(19) United States
(12) Patent Application Publication
(10) Pub. No.: US 2019/0320853 A1
(43) Pub. Date: Oct. 24, 2019

(54) CUTTING BOARD

(71) Applicants: Matt Scott, Redondo Beach, CA (US); Jonathan Fraser Regnery, Los Angeles, CA (US)

(72) Inventors: Matt Scott, Redondo Beach, CA (US); Jonathan Fraser Regnery, Los Angeles, CA (US)

(21) Appl. No.: 16/392,503

(22) Filed: Apr. 23, 2019

Related U.S. Application Data
(60) Provisional application No. 62/662,132, filed on Apr. 24, 2018.

(51) Int. Cl. A47J 47/00

(52) U.S. Cl. CPC A47J 47/005

(57) ABSTRACT

A cutting board has a planer top surface, an opposing bottom surface, and a side surface extending between the top surface and the bottom surface, a groove forming a depression in the top surface, the groove extending along a perimeter edge of the of top surface, a hole extending from the top surface through the board to the opposing bottom surface, the hole overlapping with at least a portion of the groove, a recess in the bottom surface aligned with the hole, the recess extending into the board from the bottom surface but not reaching the groove or the top surface, and two or more legs attached to the bottom surface, the legs being adjustable to change an angle of the top surface to cause liquid in the groove to flow towards the hole.

### 1. PRIORITY CLAIM

This application claims priority to and the benefit of U.S. Provisional Patent Application No. 62/662,132 filed on Apr. 24, 2018, the contents of which are incorporated by reference in its entirety herein.

### 2. FIELD OF THE INVENTION

The present invention relates to a cutting board. In particular, the present invention relates to an improved cutting board with a groove and a hole for capturing juices.

### 3. BACKGROUND OF THE INVENTION

Cutting boards or carving boards have been in use for cutting meats or the like. During cutting or carving, juices from the meat may flow onto an upper surface of the cutting board. Such cutting boards may include one or more drainage grooves to collect the juices or other liquids. The drainage grooves may be arranged along an outer edge of the board so as to not affect cutting operations on the flat surface of the board.

The drainage grooves are generally quite shallow and provide only a very limited ability to collect the juices or liquid due to the narrow and shallow grooves. As a result, the juices can overwhelm the grooves and result in messy conditions on the board, or the juices may flow off the board. An improved cutting board is desired that can retain the juices away from the cutting surface of the board, and collect the juices for later use if desired.

### SUMMARY

Aspects of embodiments of the invention include a cutting board having a planer top surface, an opposing bottom surface, and a side surface extending between the top surface and the bottom surface, a groove forming a depression in the top surface, the groove extending along a perimeter edge of the of top surface, a hole extending from the top surface through the board to the opposing bottom surface, the hole overlapping with at least a portion of the groove, a recess in the bottom surface aligned with the hole, the recess extending into the board from the bottom surface but not reaching the groove or the top surface, and two or more legs attached to the bottom surface, the legs being adjustable to change an angle of the top surface to cause liquid in the groove to flow towards the hole.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a perspective view of a cutting board according to embodiments of the invention.

FIG. 2 illustrates a top view of a cutting board according to embodiments of the invention.

FIG. 3 illustrates a bottom view of a cutting board according to embodiments of the invention.

FIG. 4 illustrates a partial perspective view of a cutting board according to embodiments of the invention.

FIG. 5 illustrates a partial view of a cutting board according to embodiments of the invention.

### DETAILED DESCRIPTIONS OF PREFERRED EMBODIMENTS

In the following description, numerous specific details are set forth in order to provide a more thorough description of embodiments of the present invention. It will be apparent, however, to one skilled in the art, that the embodiments of the present invention may be practiced without these specific details. In other instances, well-known features have not been described in detail so as not to obscure the embodiments of the present invention.

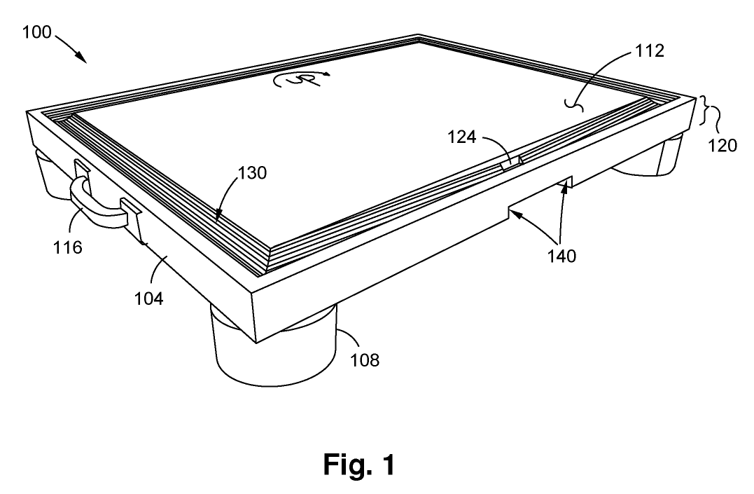

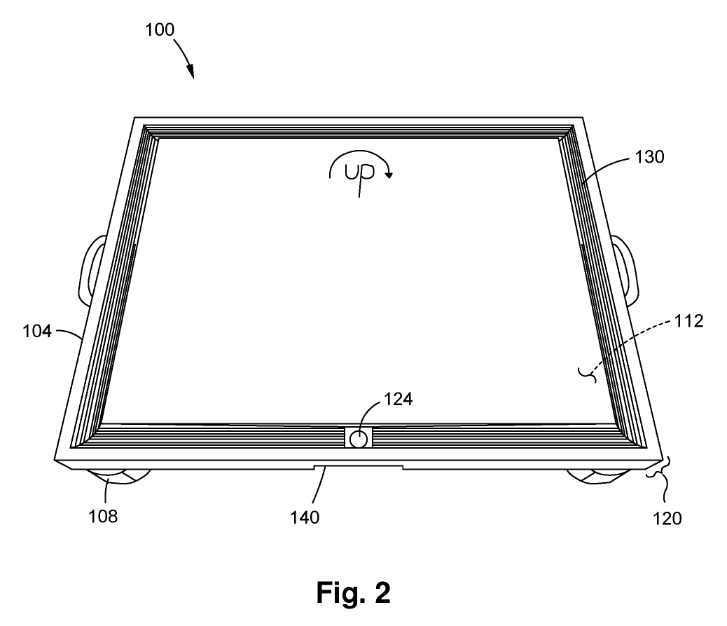

Disclosed is a cutting board as may be used for culinary or other purposes. As shown in FIGS. 1 and 2, the cutting board (hereafter “board”) 100 includes a generally planer top surface 112 and side surfaces 104. Although shown as a rectangular shape, it is contemplated that the board 100 may be any shape, including but not limited to round, square, triangular or any combination of shapes. The board 100 may be any thickness as shown by feature 120.

The board 100 may be made of any suitable material, such as wood, rubber, plastic (such as polyvinyl acetate or polyethylene), bamboo, resin, nylon, composites thereof, or other materials. The board 100 optionally includes handles 116 which may be attached to the board, or be built into the board. The handles are sized and shaped to fit a human hand such that the board 100 can be lifted off a surface by a person grabbing the handles 116. Any type of handles may be utilized, with the handles being formed from any material providing firmness and grip, such as wood, plastic, rubber, etc.

Also shown are legs 108, which are disposed on a bottom of the cutting board 100. The legs 108 may be disposed near the corners of the cutting board 100, although other positions may be utilized. The board 100 will typically have four legs 108, although fewer or more legs 108 could be utilized. The legs may be any shape such as a rectangular shape, a round shape, etc. The legs 108 may be formed from a same material as the board 100, or from another material.

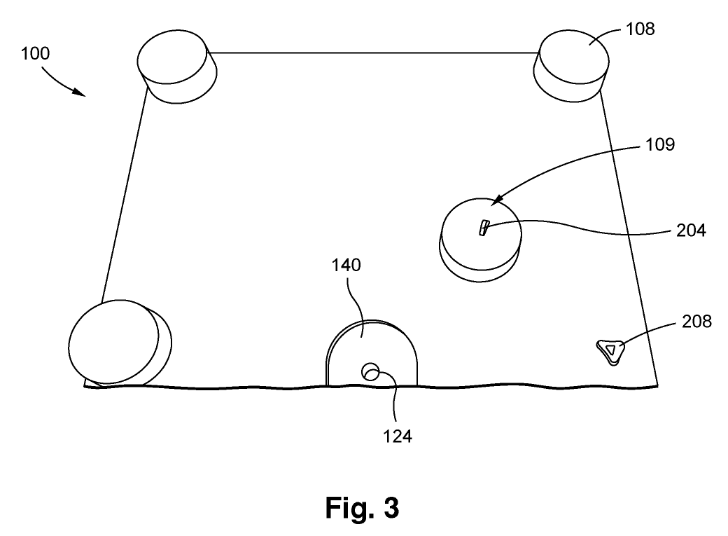

Two or more of the legs 108 may be height adjustable (in a direction perpendicular to the top surface 112) allowing for adjustment of the angle of the planer top surface 112 of the board 100 relative to a surface on which the board 100 is placed, such as a countertop. For example, in an embodiment having four legs placed at four corners of a rectangular board, a height of the legs on the back two corners of the board may be adjustable and increased relative to the height of the legs at the two front corners by adjusting the height of the back legs to provide a “forward tilt” to the board 100, with the amount of forward tilt being controllable by the amount of the height adjustment of the legs utilized. The height adjustability of the legs may be accomplished in any manner, such as is further described below in conjunction with FIG. 3.

Also shown in FIGS. 1 and 2 is a drainage groove 130 configured to capture juice, sauce, dripping, or any other type of liquid from food items placed on the board 100. The drainage groove 130 may be disposed along an entire perimeter of the board 100, along a partial perimeter of the board, or may also run through the center of the board or at any other location on the top surface 112. The drainage groove may be of varying width and depth.

A hole 124 through the board 100 is disposed in the groove 130. The hole 124 provides a channel through the board 100 to provide a path for flow of the liquid disposed in the groove 130 to an area beneath the board 100. The hole 124 may be circular, although other shapes could be used. The hole 124 may have a diameter smaller than a width of the drainage groove 130, equal to a width of the drainage groove 130 or larger than a width of the drainage groove 130. Additionally, more than one hole 124 may be provided overlapping with the drainage groove 130. In an embodiment, the hole 124 may be disposed in a position substantially in a center of a front side of the board 100, although other positions of the hole 124 may be used.

A cutout 140 is provided below the hole 124 to accept or provide additional clearance for a container 404. The container 404 is placed in the cutout 140 under the hole 124. As discussed below in more detail, the cut out 140 may have one or more channels which hold or support the container.

It is also contemplated that the depth of the drainage groove 130 may be non-level such that the groove 130 is sloped or angled to direct liquid, due to gravity pull, toward the hole 124. For example, if the hole is positioned at a front of the board near the center and the drainage groove 130 is positioned around the perimeter of the board as illustrated in FIG. 2, then left and right side portions of the drainage groove 130 may have a downward slope from back to front so that any juices or liquid in the left and right side portions of the drainage groove will flow from the back towards the front of the board 100. Also, the portion of the drainage groove 130 along the back of the board 100 may be sloped so that any liquids will flow from center portions towards the left and right edges of the board 100, to then be directed into the left and right side portions of the drainage groove 130. The portion of the drainage groove 130 along the front edge of the board 100 may be downward sloped from the left and right corners towards the center of the board 100 to direct the liquids towards the hole 124. If the hole 124 has a different placement or more than one hole is used, the slopes in the drainage groove 130 can be adjusted to direct the flow towards the hole(s). Additionally, the groove 130 may have rounded or flat side and bottom surfaces.

FIG. 3 illustrates an underside of the board 100. In this embodiment there are four legs 108 but in other embodiments a greater or fewer number of legs may be provided. In the illustrated embodiment, the legs are secured to the underside of the board 100 with a threaded attachment. A threaded rod 204 that is secured to the disconnected leg 109 is shown. A corresponding threaded attachment element 208 is secured to the underside of the board 100. A hole may be drilled in the board to provide a path for the threaded rod to advance into as the threaded rod and leg 108 is secured to the board 100. Although shown as a threaded rod 204, any type of attachment mechanism may be used to secure the legs 108 to the board while also providing height adjustment. In this embodiment, the legs 108 are located at the corners of the board or the edges of the board but in other embodiments the legs maybe be at other locations, such as on the bottom or side surface of the board 100.

A height adjustment of the legs may be provided using the threaded attachment by turning of the legs once inserted into threaded attachment element 208. This allows the legs to be raised or lowered in height. For example, if the back two legs 108 are raised in height, a forward slop to the board 100 can be provided, causing the juices to flow towards the hole 124 in the front of the board 100.

Also shown in FIG. 3 is the hole 124, which as discussed above, extends through the board 100. The cutout 140 is also shown to provide additional clearance for the container. The cutout 140 is shaped to receive the container by having a complementary shape.

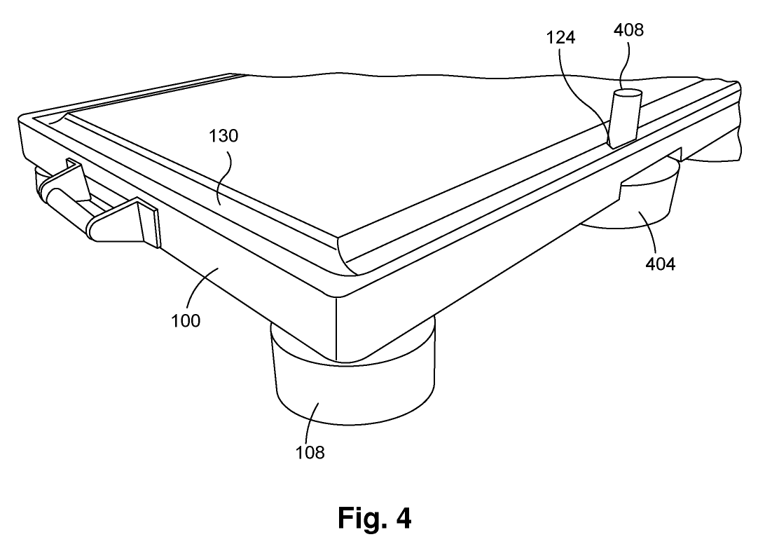

FIG. 4 is a close-up perspective view of a corner of the board 100 and leg 108. Also shown in FIG. 4 is the container 404 that is located under the hole 124. In this view, a plug 408 is in hole 124 to prevent the drainage of liquid from the groove 130 into the container 404. The plug 408 is removeable by a user. Any type of plug 408 may be used that is suitable to fill the hole 124. In one embodiment, the hole 124 is sized to accept a cork from a wine bottle as the plug 408 to thereby allow a user to use any cork from a standard size wine bottle.

The plug 408 allows the juice to be drained into the container 404 when the plug 408 is removed. Then, the plug 408 can be re-inserted into the hole 124, and the container with the juice can be removed from the cutout 140. In this manner, no juice is spilled through the hole 124 while the container is removed.

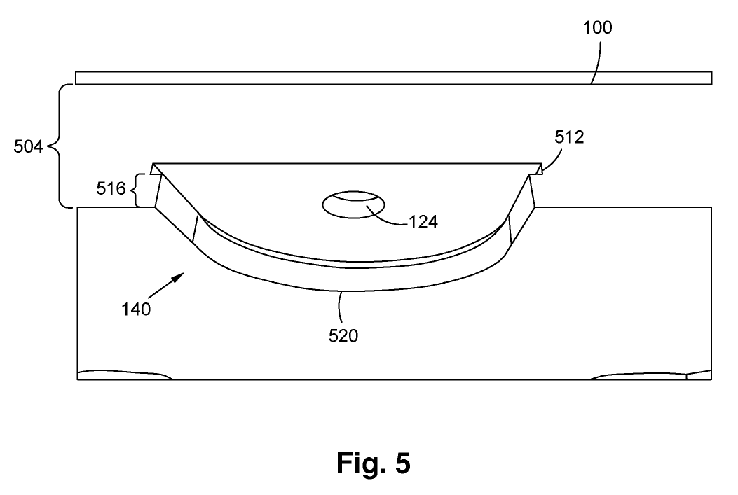

FIG. 5 illustrates the cutout 140 of the board 100 in more detail. The board 100 has a thickness 504. The cutout 140 had a depth 516. A cutout channel 512 is provided in this embodiment which extends beyond the cutout edge 520 to establish a wider portion (in a direction parallel to the top surface of board 100) of the cutout upon which a compatible container, which has an extended top edge with a lip may rest when the container is inserted into the cutout 140. The lip of the container 404 is supported by the cutout channel 512 to thereby link the board 100 and the container 404. The container 404 is configured to slide into and out of the cutout 140. The back edge of the cutout 140 may be any shape. In this embodiment, it is curved or radiused such as for use with a matching round container. The cutout 140 could also be square or linear in the back such as for use with a square or rectangular container.

In another embodiment, the cutout 140 may not include the cutout channel 512, in which case the entire cutout 140 may have a width slightly wider than any portion of the container. In this embodiment, the container 140 can be inserted into the cutout 140 and rest on the same surface that the legs 108 of the board 100 rest on.

The hole 124 is shown in the center of the cutout 140, but in other embodiments the hole 124 may be offset or at any location. In other embodiments, the board 100 may not include a cutout 140 and the container may slide under the board beneath the hole 124, the board 100 being elevated due to the height of the legs 108.

In use, the board 100 may have the height of the legs 108 adjusted by a user. For example, in embodiments with four legs 108 at the corners and the hole 124 on a front edge of the board 100, the height of the front two legs 108 could be lowered and/or the height of the back two legs 108 could be raised to provide a forward tilt to the board 100. In this manner, juice collecting in the groove 130 along the sides of the board 100 will flow towards the front of the board 100. Also, the bottom surface of the groove 130 along the front edge of the board 100 may have a downward slope extending from the front corners towards the hole 124, such that the juices will flow towards the hole 124. The juices can then flow through the hole 124 into the container 404 where the juices can be gathered for later use or disposal.

When the container 404 is inserted into the cutout 140, the lip of the cutout channel 512 holds the top edge of the container 404 in place. To remove the container 404, a user can grasp the container 404 and pull the container 404 out of the cutout 140. The container 404 can be used to dump the juices or to use the juices, such as in cooking or to put back on the meat that was cut on the board 100 or onto other food items. At this time, it may be beneficial to insert the plug 408 into the hole 124 so that no additional juices will flow through the hole 124 while the container is not present. A second container 404 could be inserted into the cutout 140 after the first container is removed, in which case the plug 408 may not be needed.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A cutting board comprising:
a board having a top surface, a bottom surface, and side surfaces extending between the top surface and the bottom surface;
a groove forming a depression in the top surface, the groove extending along a perimeter edge of the of top surface;
a hole extending from the top surface through the board to the bottom surface, the hole overlapping with at least a portion of the groove;
a cutout forming a recess in the bottom surface of the board aligned with the hole, the cutout extending into the board from the bottom surface but not reaching the groove or the top surface, the cutout forming an opening in one of the side surfaces of the board, the opening having a cut out channel formed in the one of the side surfaces, and the cut out channel is wider in a direction parallel to the top surface of the board than a portion of the opening below the cut out channel;
a container configured to be held within the cutout, the container having an upper rim with a lip portion, the lip portion sized to fit into the cutout channel of the opening but not to fit within the portion of the opening below the cutout channel; and
two or more legs attached to the bottom surface, at least one of the legs being height adjustable to change an angle of the top surface of the board to cause liquid in the groove to flow towards the hole.

2. The cutting board of claim 1, wherein the hole is formed in a front portion of the board.

3. The cutting board of claim 1, wherein the two or more legs comprise two front legs and two back legs, and the two back legs are height adjustable.

4. The cutting board of claim 1, wherein the two or more legs comprise two front legs and two back legs, and all of the legs are height adjustable.

5. The cutting board of claim 1, wherein the groove has a slope configured to cause liquid in the groove to flow towards the hole.

6. The cutting board of claim 5, wherein the groove extends along a back edge of the board, along side edges of the board and along a front edge of the board, and the groove has a downward slope from a back portion of the board to a front portion of the board in the portions of the groove extending along the side edges of the board.

7. The cutting board of claim 6, wherein the portion of the groove extending along the front portion of the board is sloped towards the hole.

8. A cutting board comprising:
a board having a planer top surface, an opposing bottom surface, and a side surface extending between the top surface and the bottom surface;
a groove forming a depression in the top surface, the groove extending along a perimeter edge of the of top surface;
a hole extending from the top surface through the board to the opposing bottom surface, the hole overlapping with at least a portion of the groove;
a cutout forming a recess in the bottom surface aligned with the hole, the cutout extending into the board from the bottom surface but not reaching the groove or the top surface; and
two or more legs attached to the bottom surface, the legs being adjustable to change an angle of the top surface to cause liquid in the groove to flow towards the hole.

9. The cutting board of claim 8, wherein the cutout includes an opening formed in the side surface of the board.

10. The cutting board of claim 9, wherein the opening having a cutout channel formed in the one of the side surfaces, and the cutout channel is wider in a direction parallel to the top surface of the board than a portion of the opening below the cutout channel.

11. The cutting board of claim 8, wherein the hole is formed in a front portion of the board.

12. The cutting board of claim 8, wherein the two or more legs comprise two front legs and two back legs, and the two back legs are height adjustable.

13. The cutting board of claim 8, wherein the two or more legs comprise two front legs and two back legs, and all of the legs are height adjustable.

14. The cutting board of claim 8, wherein the groove has a slope configured to cause liquid in the groove to flow towards the hole.

15. The cutting board of claim 8, wherein the groove extends along a back edge of the board, along side edges of the board and along a front edge of the board, and the groove has a downward slope from a back portion of the board to a front portion of the board in the portions of the groove extending along the side edges of the board.

16. The cutting board of claim 15, wherein the portion of the groove extending along the front portion of the board is sloped towards the hole.

17. A method of forming a cutting board, comprising:
providing a board having a planer top surface, an opposing bottom surface, and a side surface extending between the top surface and the bottom surface;
forming a groove having a depression in the top surface, the groove extending along a perimeter edge of the of top surface;
forming a hole extending from the top surface through the board to the opposing bottom surface, the hole overlapping with at least a portion of the groove;
forming a cutout having a recess in the bottom surface aligned with the hole, the cutout extending into the board from the bottom surface but not reaching the groove or the top surface; and
attaching two or more legs to the bottom surface, the legs being adjustable to change an angle of the top surface to cause liquid in the groove to flow towards the hole.

18. The method of claim 17, wherein the cutout is formed with an opening in one of the side surfaces of the board, the opening having a cutout channel formed in the one of the side surfaces, and the cutout channel is wider in a direction parallel to the top surface of the board than a portion of the opening below the cut out channel.

19. The method of claim 18, further comprising providing a container configured to be held within the cutout, the container having a upper rim with a lip portion, the lip portion sized to fit into the cutout channel of the opening but not to fit within the portion of the opening below the cutout channel.

20. The method of claim 17, wherein forming the groove comprises forming the groove having a slope configured to cause liquid in the groove to flow towards the hole.
